(19) United States
(12) Patent Application Publication
(10) Pub. No.: US 2013/0136334 A1
(43) Pub. Date: May 30, 2013

(54) Semiconductor Inspecting Apparatus

(71) Applicants: Yuichi Sakurai, Tokyo (JP); Tadanobu Toba, Yokohama (JP); Hideki Yasumoto, Mito (JP); Ken Iizumi, Hitachinaka (JP); Yoshiyuki Momiyama, Yokohama (JP)

(72) Inventors: Yuichi Sakurai, Tokyo (JP); Tadanobu Toba, Yokohama (JP); Hideki Yasumoto, Mito (JP); Ken Iizumi, Hitachinaka (JP); Yoshiyuki Momiyama, Yokohama (JP)

(73) Assignee: Hitachi High-Technologies Corporation, Minato-ku,Tokyo (JP)

(21) Appl. No.: 13/807,707

(22) PCT Filed: May 18, 2011
(86) PCT No.: PCT/JP2011/002751

§ 371 Date: Feb. 12, 2013

(30) Foreign Application Priority Data
Jun. 30, 2010 (JP) 2010-148491

(51) Int. Cl. G06T 7/00

(52) U.S. Cl. CPC G06T 7/0004
USPC 382/145

(57) ABSTRACT

A semiconductor inspecting apparatus which is provided with an inspecting unit, a detecting unit, and a processing unit, which processes an image on the basis of reflection light detected by the detecting unit, and which inspects the surface of the subject to be inspected. The processing unit is provided with an image distribution control unit, which distributes the image, and an image processing unit, which processes the image distributed by the image distribution control unit. The image distribution control unit has and image buffer counter, which counts the input image quantity of the image; a distribution control table, which stores information relating to the image; and a distribution timing control circuit, which determines distribution start timing of the image on the basis of the input image quantity and the information relating to the image obtained from the distribution control table.

### TECHNICAL FIELD

The present invention relates to a semiconductor inspecting apparatus.

### BACKGROUND ART

Since semiconductor integrated circuit devices are finer, the density of substrate wiring is higher, and so on today, the circuit pattern formed on a semiconductor wafer is rapidly becoming finer. In association therewith, for the semiconductor visual inspecting apparatus (semiconductor inspecting apparatus) represented by wafer visual inspecting apparatus and a scanning electron microscope, the required image processing performance is increasing year by year; and for an image processing device, it is required to secure scalability corresponding to increase in the image data quantity which can be simultaneously processed and flexibility of an image processing device configuration corresponding to update of the image processing method.

As inspecting apparatus corresponding to the securing of scalability of an image processing device, Patent Literature 1 (JP-A-2005-274172) discloses “a pattern inspection device characterized by comprising stage means on which a sample with a pattern formed in a surface thereof is mounted and which can continuously move in at least one direction, imaging means to image the sample mounted on the stage means when the stage means is continuously moving in one direction, image processing means including a dividing unit to divide an image of the sample obtained by imaging by the imaging means into a plurality of successive partial images which are partly overlapped with each other and a plurality of processing units to concurrently process, by use of a plurality of processor elements, the successive partial images divided by the dividing unit, to thereby detect defect in the pattern on the sample surface; and control means to control the stage means, the imaging means, and the image processing means.”; there has been reported a pattern inspection device which implements, by disposing a plurality of processing units to concurrently execute processing by use of a plurality of processor elements, the scalability corresponding to the increase in image data quantity which can be simultaneously processed.

Further, Non Patent Literature 1 (InfiniBand Trade Association http://www.infinibandta.com.) discloses that from the viewpoint of the securing of scalability and flexibility, the InfiniBand® architecture which is a trend in the field of general supercomputers is employed as a data distribution network in many cases.

Also, Non Patent Literature 2 (NASA Advanced Supercomputing Division: NAS Computing Resources—Pleiades Supercomputer: http://www.nas.nasa.gov/Resources/Systems/pleiades.html (2009)) discloses an example in which InfiniBand® is applied to a general Supercomputer.

InfiniBand® has scalability for the data transfer capacity corresponding to a plurality of generations. For InfiniBand® started with SDR (Single Data Rate, 2.5 Gbps/1×) in 2001, there have been proposed standards up to EDR (Eight×Data Rate, 20 Gbps/1×). Also, it is capable of managing a maximum of 64000 processor nodes (terminals) and has scalability for the increase in the required processing performance. Further, it is an architecture adopting switch-type fabric and has flexibility in the network topology. As above, the InfiniBand® architecture has scalability for the increase in the data transfer capacity and the required processing performance and flexibility in the network topology, and implements the securing of the scalability for the request to increase the speed corresponding to several generations and the flexibility for the development of image processing algorithms due to customer's requirements, improvement in functions, and the like; and meets the need for higher performance existing in the semiconductor visual inspecting apparatus and scientific systems.

A network (InfiniBand® network hereinbelow) adopting the InfiniBand® architecture ordinarily includes a workstation in which a CPU, an OS, and driver software are mounted, but the real-time property is not taken into consideration; hence, it is not applicable to the semiconductor visual inspecting apparatus; further, from the viewpoint of easiness of incorporation, it has been required to implement remarkable miniaturization.

As an example in which a general network protocol as for the InfiniBand® network is applied to a device for which the real-time property is required, there may be cited Patent Literature 2 (JP-A-2009-181203). Patent Literature 2 discloses “a bus arbitration device to conduct bus arbitration by setting a priority order in conducting access to a common memory of a CPU to be higher in executing processing for which the real-time property is requested than that in executing processing for which the real-time property is not requested, and by setting the maximum burst length in conducting access to the common memory to be shorter than the normal length when the priority of the CPU is set high.”

### CITATION LIST

### Patent Literature

PATENT LITERATURE 1: JP-A-2005-274172
PATENT LITERATURE 2: JP-A-2009-181203

### Non Patent Literature

NON PATENT LITERATURE 1: InfiniBand Trade Association. http://www.infinibandta.com.
NON PATENT LITERATURE 2: NASA Advanced Supercomputing Division: NAS Computing Resources—Pleiades Supercomputer: http://www.nas.nasa.gov/Resources/Systems/pleiades.html (2009)

### SUMMARY OF INVENTION

### Technical Problem

In semiconductor visual inspecting apparatus to process a large volume of data by using a plurality of computers in a real-time fashion, input data is divided into regular-sized data items to be sequentially distributed to the respective parallel computers for the processing thereof. In the processing, if variation takes place in the latency to sequentially distribute the data items to the respective processors, the arrival timing of processing data at the respective processors of the parallel processing device varies. When the variation is accumulated, a failure occurs in the consistency of data processing and the control sequence. That is, the latency time management to sequentially distribute data items from the image distribution control unit to the respective computers is important.

However, according to the bus arbitration device described in Patent Literature 2, a single CPU bus is shared among a plurality of communication means, a CPU, and a bus arbitration circuit; hence, in a situation in which a large quantity of data is written (buffered) in a main memory such that for the data, when the data is sequentially distributed to the respective computers, there exit a problem in which contention occurs among the respective data and hence the latency time management for the sequential distribution cannot be conducted and a problem in which transmission schedule (timing) control is performed by the software control of the CPU and hence contention occurs between the writing (buffering) control of a large quantity of data in the main memory and the transmission schedule (timing) control by software processing, and the writing (buffering) of a large quantity of successive data in the main memory is interrupted by the software processing or the software control by the CPU is suspended by an interruption due to the writing (buffering) control of a large quantity of data in the main memory, or the like, and hence the latency time management for the sequential distribution cannot be conducted; therefore, it is required to solve the problem of the contention regarding the data buffering in the main memory and the distribution control and the problem of the contention taking place due to the data transmission schedule (timing) control of the CPU.

The present invention has an object to implement high-performance semiconductor visual inspecting apparatus at low cost by increasing the real-time property of the general parallel processing device.

### Solution to Problem

An outline of representative inventions disclosed by the present application will be simply described as below.

(1) Semiconductor inspecting apparatus, comprising an inspecting unit which images a surface of a target inspection object; a detecting unit which detects reflection light from the surface of the target inspection object imaged by the inspecting unit; and a processing unit which processes an image based on the reflection light from the surface of the target inspection object detected by the detecting unit and which inspects the surface of the target inspection object, wherein the processing unit comprises an image distribution control unit which distributes the image and an image processing unit which processes the image distributed by image distribution control unit, and the image distribution control unit comprises an image buffer counter which counts an input image quantity of the image, a distribution control table which stores therein information regarding the image, and a distribution timing control circuit which determines distribution start timing of the image based on the input image quantity counted by the image buffer counter and the information regarding the image from the distribution control table.

### Advantageous Effects of Invention

According to the present invention, it is an object to provide high-performance, low-cost semiconductor visual inspecting apparatus by increasing the real-time property of the general parallel processing device.

### BRIEF DESCRIPTION OF DRAWINGS

FIG. 1 is an explanatory diagram of a first embodiment of semiconductor visual inspecting apparatus according to the present invention.

FIG. 2 is an explanatory diagram showing an appearance of parallel image processing in the semiconductor visual inspecting apparatus according to the present invention.

FIG. 3 is an example of a distribution control table in the semiconductor visual inspecting apparatus according to the present invention.

FIG. 4 is a distribution control sequence chart (1) in the semiconductor visual inspecting apparatus according to the present invention.

FIG. 5 is a distribution control sequence chart (2) in the semiconductor visual inspecting apparatus according to the present invention.

FIG. 6 is a diagram showing a flow of image sequential distribution to processors in the semiconductor visual inspecting apparatus according to the present invention.

FIG. 7 is an explanatory diagram of conventional semiconductor visual inspecting apparatus using the InfiniBand® network control.

FIG. 8 is an explanatory diagram of a flow of image distribution control in the conventional semiconductor visual inspecting apparatus using the InfiniBand® network control.

### DESCRIPTION OF EMBODIMENTS

### Embodiment 1

Next, description will be given of an embodiment of semiconductor manufacturing apparatus according to the present invention by use of semiconductor inspecting apparatus as an example by referring to the drawings. As specific examples of semiconductor inspecting apparatus, there are optical and SEM visual inspecting apparatus and SEM length measuring apparatus.

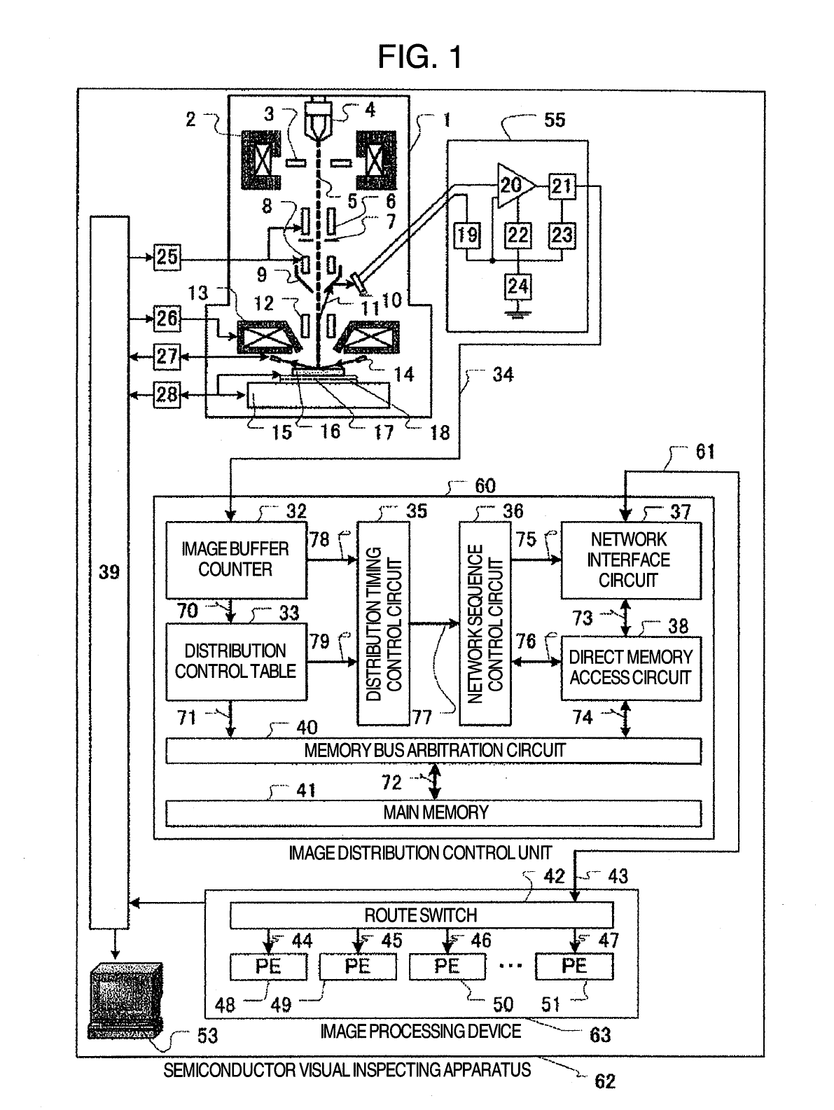

FIG. 1 is an explanatory diagram of a first embodiment of semiconductor visual inspecting apparatus according to the present invention. The semiconductor visual inspecting apparatus 62 is configured by disposing an inspection chamber 1 in which an electron beam is radiated onto a target inspection substrate 16 to thereby generate secondary electrons from the target inspection substrate 16, a standby chamber (not shown in this embodiment), a secondary electron detecting unit 55 to detect secondary electrons generated from the target inspection substrate 16, a processing unit in which image data based on the secondary electrons detected by the secondary electron detecting unit 55 is processed to thereby inspect a surface of the target inspection substrate, and a control unit (overall control unit) 39 which carries out control of an inspection condition in the inspection chamber 1, monitor display of the data processed by an image processing device 63, and the like.

In the configuration, the processing unit includes an image distribution control unit 60 to distribute image data based on secondary electrons and an image processing unit (image processing device) 63 to process image data distributed by the image distribution control unit 60.

The inspection chamber 1 is exhausted to a vacuum and is configured using a radiation system, a detection system, and a stage system.

The radiation system is configured by disposing an electron gun 4, an electrode 3 to draw an electron beam 5, a condenser lens 2, a blanking deflector 6, a scanning deflector 8, an iris 7, an objective lens 13, a reflector 9, and an ExB deflector 12.

The stage system is configured by disposing a sample stage 15 on which a target inspection substrate 16 as a target inspection object is mounted, and an X stage 17 and a Y stage 18 mounted on the sample stage 15; detects secondary electrons 11 generated from the target inspection substrate 16 due to the radiation system by a secondary electron detector 10 as a detection system, and sends them to a secondary electron detecting unit 55.

The target inspection substrate 16 is a semiconductor wafer, a chip or a substrate including a fine circuit pattern of liquid-crystal, mask, or the like.

To obtain an image of the target inspection substrate 16, a narrow-shaped electron beam 5 is radiated onto the target inspection substrate 16 to generate secondary electrons 11 to detect them in synchronism with the scanning of the electron beam 5 and the movement of the X stage 17 and the Y stage 18, to thereby obtain the image of the target inspection substrate 16.

The electron beam 5 is accelerated by applying negative potential of a high voltage to the electron gun 4. As a result, the electron beam 5 proceeds in the direction to the sample stage 15 with energy associated with the potential and is converged by the condenser lens 2 and is further shaped narrower by the objective lens 13 to be radiated onto the target inspection substrate 16 mounted on the X stage 17 and the Y stage 18 on the sample stage 15.

The secondary electrons 11 generated by radiating the electron beam 5 onto the target inspection substrate 16 are accelerated by the negative voltage applied to the target inspection substrate 16. Over the target inspection substrate 16, there is arranged the ExB deflector 12 to bend the track of the secondary electrons by both of an electric field and a magnetic field without exerting influence upon the track of the electron beam 5; and secondary electrons 11 accelerated as above are deflected in a predetermined direction. The deflection quantity can be adjusted by the intensity of the electric field and the magnetic field applied to the ExB deflector 12. The secondary electrons 11 deflected by the ExB deflector 12 collide with the reflector 9 under a predetermined condition.

When the accelerated secondary electrons 11 collide with the reflector 9, second secondary electrons having energy of several eV to 50 eV are generated from the reflector 9. The secondary electron detector 10 is so configured to detect the second secondary electrons generated when the secondary electrons 11 collide with the reflector 9, in association with the scanning timing of the electron beam 5.

Here, the operation instructions and the operation conditions of respective units of the apparatus are inputted from or outputted to the overall control unit 39.

The blanking deflector 6 is connected to a deflection control unit 25 to generate a scanning signal and a blanking signal. The frequency, the deflection width, and the like of deflection of the electron beam by the scanning deflector 8 are controlled by the deflection control unit 25 based on instructions from the overall control unit 39, to thereby conduct two-dimensional scanning of the electron beam 5 on the target objective substrate 16. Incidentally, if blanking is required for the electron beam 5, it is possible to conduct control such that the electron beam 5 is deflected by the blanking deflector 6 so as not to pass through the iris 7.

Further, the numerical aperture and the like of the objective lens 13 are controlled by an objective lens control unit 26 based on instructions from the overall control unit 39.

In the operation, the X stage 17 and the Y stage 18 are controlled by a stage drive control unit 28 to conduct drive control in the x and y directions based on a stage control signal obtained from the control unit (overall control unit) 39.

The secondary electron detection unit 55 is configured by disposing a preamplifier 20, an AD converter 21, a high-voltage power source 24, a preamplifier drive power source 22, an AD converter drive power source 23, and a reverse bias power source 19. Further, the secondary electron detector 10 as part of the secondary electron detection unit 55 is arranged over the objective lens 13 in the inspection chamber 1 to detect secondary electrons from the target inspection substrate 16.

An output signal from the secondary electron detector 10 is amplified by the preamplifier 20 of the secondary electron detection unit 55 and is converted through the AD converter 21 to digital data. The AD converter 21 is configured such that an analog signal which is detected by the secondary electron detector 10 and which is amplified by the preamplifier 20 is thereafter immediately converted into a digital signal to be transmitted to the image distribution control unit 60.

The AD converted SEM image is sent via the image distribution control unit 60 to the image processing means (image processing device) 63 and is then processed. For example, for a length measuring SEM, distance between patterns in a designated image is measured in the image processing unit 63. Further, for an observation SEM (visual inspection based on SEM images), processing such as image emphasis is executed in the image processing unit 63.

Thereafter, an electron-beam image or an optical image thus obtained is displayed on a monitor 53.

Next, description will be given of a detailed embodiment of the image distribution control unit 60.

The image distribution control unit 60 is configured by disposing an image buffer counter 32, a distribution control table 33, a distribution timing control circuit 35, a network sequence control circuit 36, a network interface circuit 37, a direct memory access circuit 38, a memory bus arbitration circuit 40, and a main memory 41.

The image distribution control unit 60 has a function to divide successive image data 34 outputted from the secondary electron detection unit 55 into processing-unit images and to distribute them to predetermined processor elements 48, 49, . . . 51 arranged in the image processing device 63.

First, when the successive image data 34 is inputted to the image distribution control unit 60, the input image quantity is counted by the image buffer counter 32. Next, successive image data 70 after the counting of the input image quantity by the image buffer counter 32 is inputted to the distribution control table 33. In the distribution control table 33, there are collected a division range, a division size, a distribution destination processor element, and the like of the successive image data 70. According the distribution control table 33, the successive image data 70 is divided and header information indicating an ID number representing each processor element, an image size, and a physical address is added to the successive image data 70, and thereafter, successive image data 71 after the addition is stored via the memory bus arbitration circuit 40 and a memory bus 72 in the main memory 41 in the image distribution control unit 60. Here, the memory bus arbitration circuit 40 conducts arbitration for the access to the main memory 41 between the successive image data 71 for the buffering (writing) and distribution data 74 for the reading and writing. As an example of the arbitration method, a round robin method to alternately process the respective access operations is employed, and the arbitration processing is executed at a speed twice the bus speed of each of the successive image data 71 and the distribution data 74.

Incidentally, an image coordinate value is a value to represent an image position on the wafer. Image coordinate values stored in a plurality of rows in the distribution control table 33 represent groups of image data items to be processed respectively by the predetermined processor elements 48, 49, . . . 51 arranged in the image processing device 63, as ranges of scan image coordinates on the wafer. That is, the successive image data 34 in a range from image coordinate values 100 to 200 in the distribution control table 33 is to be image-distributed to a processor element ID 3. That is, it can be considered that the image coordinate values stored in a plurality of rows in the distribution control table 33 are employed as reference values to start the distribution.

The distribution timing control circuit 35 compares, since a counter value 78 of the image buffer counter 32 and information 79 of the distribution control table 33 are inputted thereto, the output (counter value) 78 from the image buffer counter with the image coordinate value in the distribution control table 33, and detects, when both values are equal to each other, an event in which a fixed quantity of image data is buffered in the main memory 41. After having detected the buffering of a fixed quantity of image data, the distribution timing control circuit 35 sends a distribution start indication 77 to the network sequence control circuit 36.

Here, description will be given of the difference between Patent Literature 2 and the present invention for the distribution timing control and the control for the distribution start indication.

In Patent Literature 2, the CPU creates the data transmission schedule (timing) to the PLC network, by software processing. Then, when conducting the schedule (timing) creation to retain the real-time property, the bus arbitration circuit conducts control to temporarily heighten the priority level on the CPU side, according to the description. Assume a situation in which the scheduling (timing) creation method by the CPU of Patent Literature 2 is applied to, for example, the image distribution of the semiconductor visual inspecting apparatus of the present invention. That is, the CPU performs the scheduling (timing) control to distribute the successive image data 34 outputted from secondary electron detection unit 55 to the predetermined processor elements 48, 49, . . . 51 arranged in the image processing device 63.

In this situation, the scheduling (timing) control due to interruption by the CPU is conducted with a high priority level in the memory bus arbitration processing (505) for the main memory 41. That is, the bus arbitration circuit (505) stops the successive image data 34 and gives priority to the access to the main memory 41 associated with the scheduling (timing) control by the CPU. However, in the semiconductor visual inspecting apparatus according to the present invention, it is not possible to stop the successive image data 34 outputted from secondary electron detection unit 55, and overflow occurs on the image input side due to the scheduling processing by the CPU; hence, the image distribution processing is not possible and the apparatus stops the processing.

Further, during the CPU processing of the scheduling (timing) control, data transmission on the PLC network is neither conducted in Patent Literature 2; hence, if the scheduling (timing) control is applied to the image distribution of the semiconductor visual inspecting apparatus of the present invention, the distribution processing to the processor elements 48, 49, . . . 51 is stopped, and the distribution processing also delays and variation occurs in the distribution latency.

As above, in the semiconductor visual inspecting apparatus as an object of the present invention, it is difficult to execute the scheduling processing of the image distribution processing by the software processing by use of the CPU, which is the control method of Patent Literature 2; in contrast therewith, the present invention has implemented the scheduling (timing) control by disposing the image buffer counter 32 to count the input image quantity of an image, the distribution control table 33 to store therein information regarding the image, and the distribution timing control circuit 35 to determine distribution start timing of the image based on the input image quantity counted by the image buffer counter 32 and the information regarding the image from the distribution control table described above.

The network sequence control circuit 36 is a circuit to control the network interface circuit 37 and controls, according to an indication 77 from the distribution timing control circuit 35, the network interface circuit 37 to execute image data distribution processing to the parallel processors 48, 49, . . . 51 in the image processing device 63.

Next, the network sequence control circuit 36 reads image data with a header from the main memory 41. In the operation, it directly accesses via the direct memory access circuit 38 a physical address in the main memory 41. The network sequence control circuit 36 reads via a bus 76 the image data with a header read from the main memory 41 and reads an image size, a transfer destination PE, and transfer destination address information of the header information. By using these information pieces, the network sequence control circuit 36 controls the network interface circuit 37. The network interface circuit 37 executes, according to the network sequence control circuit 36, image data distribution processing through an image distribution network 43.

Next, description will be given of a detailed embodiment of the image processing device 63.

The image processing device 63 includes a route switch 42 to change the route of image data divided by the image distribution control unit 60 and the processor elements 48, 49, 50, . . . 51 to execute processing of the image data the route of which is changed by the route switch 42.

The image distribution control unit 60 divides the successive image data into images in basic image units and allocates them to the plurality of processors of the image processing device 63, to thereby conduct the defect inspection.

The image signal of the target inspection substrate 16 detected by the secondary electron detector 10 is stored in the main memory 41 or the processor elements 48, 49, 50, . . . 51.

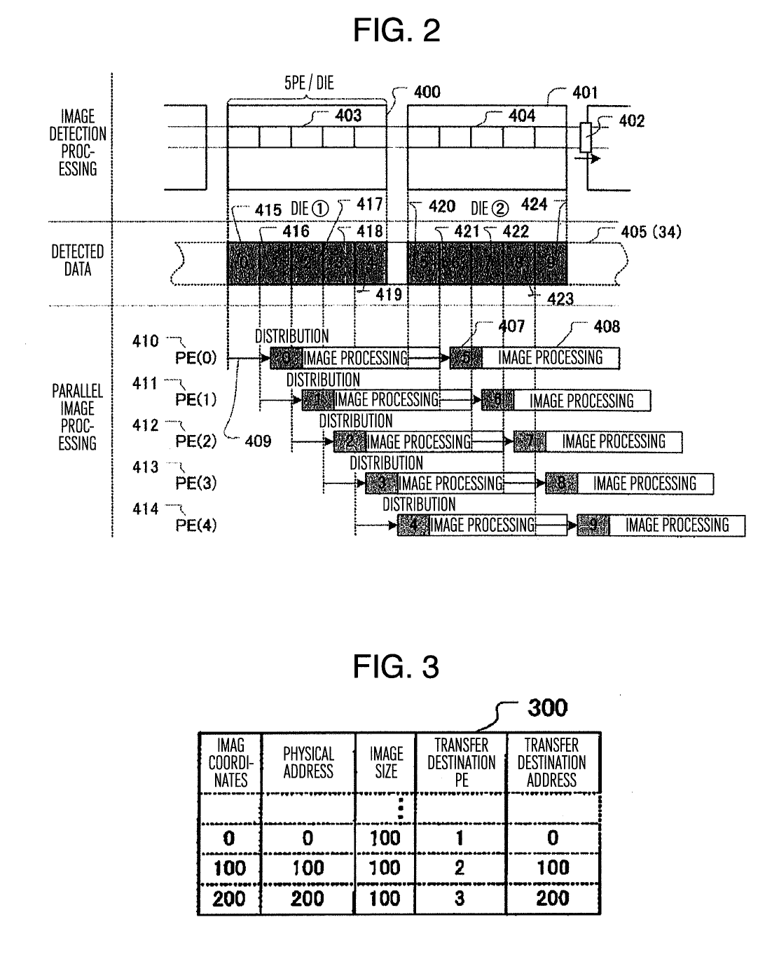

FIG. 2 is an explanatory diagram showing an appearance of parallel image processing in the semiconductor visual inspecting apparatus according to the present invention.

Here, description will be given of processing to divide a die-unit input image into a fixed quantity of data.

In FIG. 2, there are shown five processor elements 410 to 414 (corresponding to 48, . . . 51 of FIG. 1) and image data distribution and image processing timing in the respective processor elements 410 to 414.

The first image 415, in a die (1) of the successive image data 34 sent from the secondary electron detection unit 55 to the image distribution control unit 60, is transferred to the processor element 410, the second image 416 of the die scan successive image data (die (1)) is transferred to the processor element 411, and so on; similarly thereafter, images 417 to 419 are sequentially transferred to the respective processor elements 412 to 414. Incidentally, the data, which is the detection data associated with the die (1), respectively transferred to the processor elements 410 to 414 will be referred to as first image data.

Next, the scanning is continuously carried out on the target inspection object (wafer) to transfer a scan image 404 of the next die (2) 401 to the processor elements 410 to 414. In the same way as for the die (1), the first image 420 of the die scan successive image data is transferred to the processor element 410 and the second image 421 is transferred to the processor element 411; similarly thereafter, images 422 to 424 are sequentially transferred to the processor elements 422 to 424.

The data, which is the detection data associated with the die (2), respectively transferred to the processor elements 410 to 414 will be referred to as second image data.

Each processor element executes image processing for the distributed data. For example, the processor element 410 distributes 407 the image 420 of the die (2) 401 and then successively executes image processing 408. Here, the interval from the image detection to the image distribution to the processor elements will be referred to as image distribution latency 409.

The foregoing describes the image division method in the semiconductor visual inspecting apparatus according to the present invention.

In FIG. 1, the processor elements 48 to 51 receive as inputs thereto the successive image data and have one and the same function. The respective processor elements execute defect judge processing respectively for images divided in basic image data units; and defect information detected in the processing is stored via the route switch 42 in the overall control unit 39. The positions and the number of defects are displayed on the monitor 53.

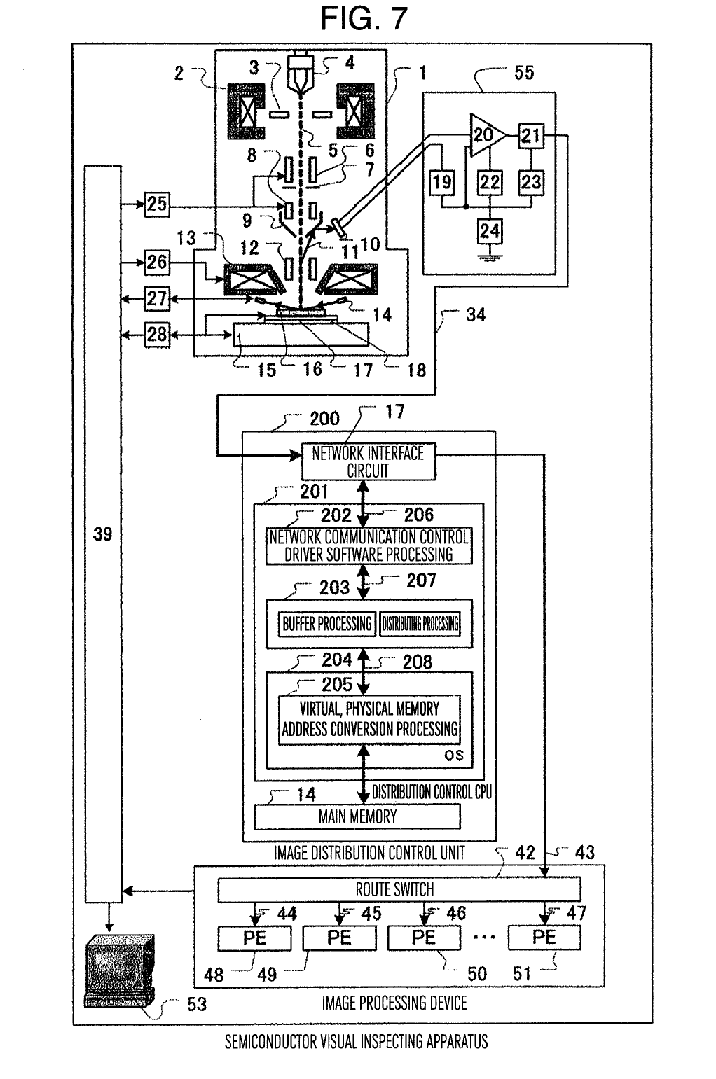

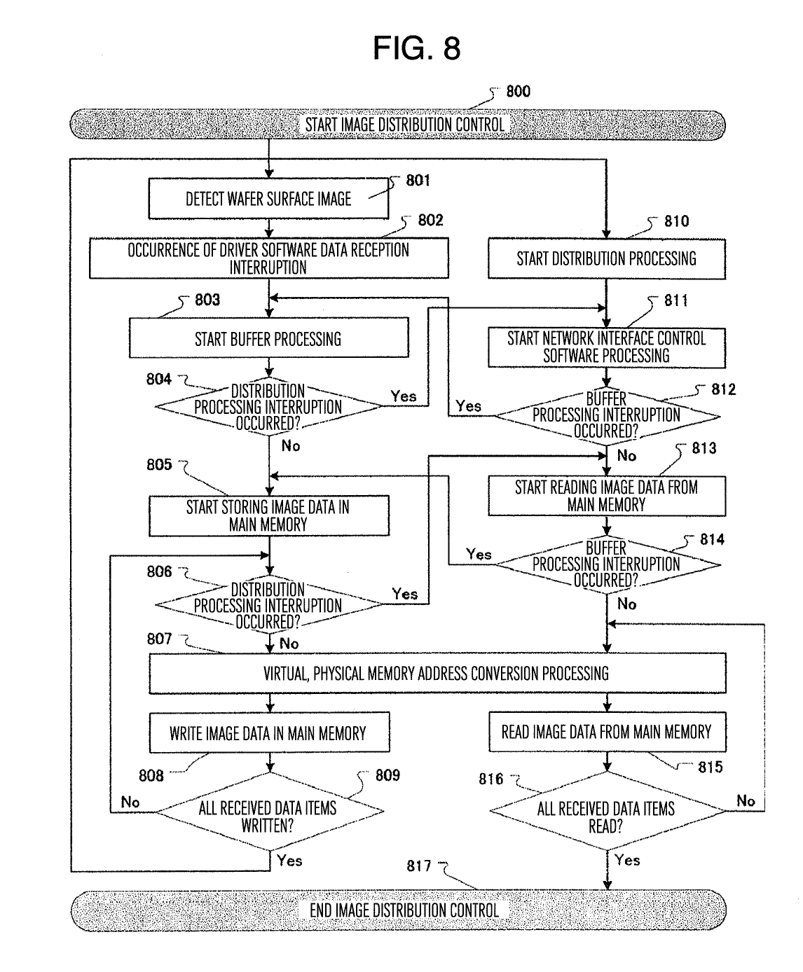

Here, description will be given of, as a conventional technique, an embodiment of semiconductor visual inspecting apparatus including an image distribution control unit using an existing InfiniBand® network configuration by referring to FIGS. 7 and 8.

FIG. 7 is an explanatory diagram of conventional semiconductor visual inspecting apparatus using the InfiniBand® network control, and FIG. 8 is an explanatory diagram of a flow of image distribution control in the conventional semiconductor visual inspecting apparatus using the InfiniBand® network control.

On a workstation as an image distribution control unit 200, there are mounted a single CPU 201, an Operating System (OS) 204, and driver software 202 to control a network interface circuit 17.

The image distribution control unit 200 buffers regular-sized data size in a memory 14 by use of buffer processing software 203 and then activates transmission control software 203, to sequentially distribute processing data via an InfiniBand® network 43 to the respective computers 48, 49, . . . 51.

The control flow will be described by referring to the sequence chart of FIG. 8. A wafer surface image is detected by the SEM image detection processing (800). The detected image data is inputted to the image distribution control unit 200. Due to the data input, the network communication control driver software to control the network interface circuit issues a notification to the CPU by use of interruption (802).

The CPU activates the buffer processing software to start data buffering processing (803). If interruption by the distribution control software has not occurred (804), the buffer processing software starts storing the inputted image data in the main memory (805). If interruption by the distribution control software has not occurred (806), the buffer processing software stores the image data in the main memory by use of an interface of the OS. The OS converts a virtual memory address of the user area into a physical memory address (807) to store desired image data in the main memory (808).

If the received image data items of fixed size have been entirely written (809), the buffer processing software activates distribution processing software to start distribution processing (810). Here, if interruption by the buffer processing software has not occurred (812), the distribution processing software uses the network communication control driver software (811) to sequentially distribute data via a distribution network to the parallel processors.

The network communication control driver software starts reading image data from the main memory (813). Here, if interruption by the buffer processing software has not occurred (814), the driver software reads image data from the main memory by use of an interface of the OS.

The OS converts a virtual memory address of the user area into a physical memory address (807) to read desired image data from the main memory (815). The image data thus read is sequentially distributed via the network interface circuit and the distribution network to the parallel processors. If the distributed image data items are completely read (816), the image distribution control is finished (817).

In the operation, variation takes place in the distribution latency time from the start of the network sequence control circuit to the distribution to the respective processor elements. The reason will be described by referring to FIG. 7.

This is because the OS 204 on one CPU 201 conducts the distribution processing and the buffer memory control, and two contention events below take place and the distribution latency varies.

The first contention is associated with the buffer memory control. Under control of the OS 204, at memory access, the conversion processing 205 between the virtual memory address and the physical memory address is executed; in the distribution control unit 200, the memory access 208 occurs in the buffer processing and the distribution processing 203; hence, a contention state appears. If address conversion request interruption due to the buffer processing takes place during the distribution processing, the distribution processing stops and the distribution latency varies.

The second contention is associated with the distribution control and the buffering processing. Also when the distribution control unit 200 is sequentially distributing data to the respective processors 48, 49, . . . 51, the processing data 34 is buffered in parallel thereto; hence, the network communication control driver software 200 interrupts the CPU 201 to change the task to the buffer processing 203. Hence, the data distribution stops and the latency varies.

In this fashion, as tasks to operate under the OS 204 on the single CPU 201, the distribution control and buffering processing contend with each other; hence, variation occurs in the distribution latency due to interruption.

Here, description will be given of a feature of the present invention, that is, the image distribution processing in the semiconductor visual inspecting apparatus including an image distribution control unit to suppress the variation in the latency of the image data sequential distribution to the parallel processors.

As for the configuration, it is assumed to include the image distribution control unit shown in FIG. 1 and the distribution control table shown in FIG. 3.

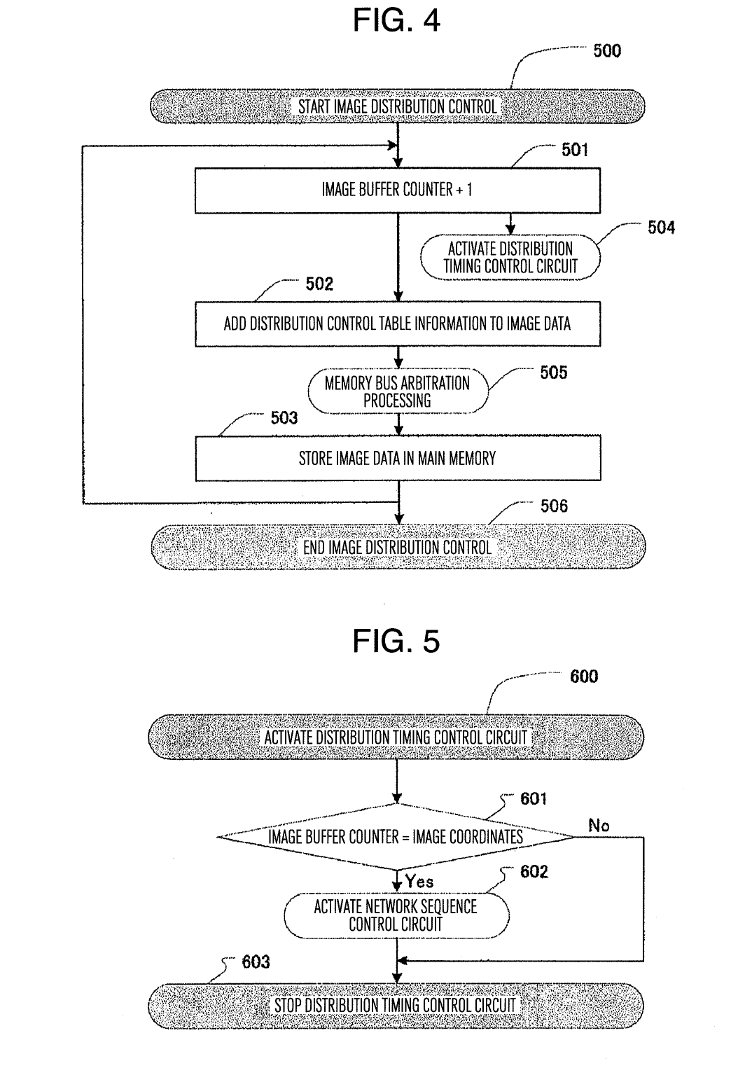

FIG. 4 is a distribution control sequence chart (1) in the semiconductor visual inspecting apparatus according to the present invention.

A wafer surface image is detected by the SEM image detection processing (500). The detected image data is inputted to the image distribution control unit 60 and passes through the image buffer counter. In the operation, the image buffer counter adds one to the counter value (501). Next, the image distribution control unit 60 sends the image data to the distribution control table to add the distribution control table information to the image data (502) and simultaneously activates the distribution timing control circuit (504). The image data to which the distribution control information is added passes through the memory bus arbitration processing (505) and then the image data is stored in the main memory (503). The foregoing describes the storing processing of the image data in the main storage.

Next, description will be given of processing after the distribution timing control circuit is activated. Description will be given thereof by referring to the sequence chart of FIG. 5. When the distribution timing control circuit is activated (600), the distribution timing control circuit compares the value of the image buffer counter and the image coordinate value in the distribution control table (601). If this results in equal (equal in the value), the distribution timing control circuit activates the network sequence control circuit (602). Then, the processing of the distribution timing control circuit is finished (603).

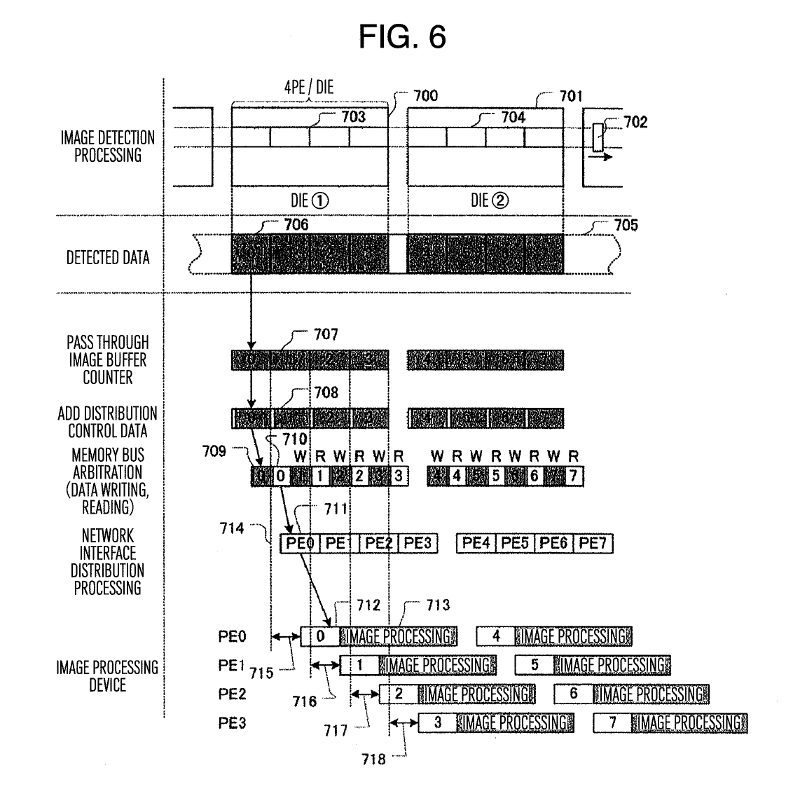

FIG. 6 is a diagram showing a flow of image sequential distribution to processors in the semiconductor visual inspecting apparatus according to the present invention.

Detection data of the die (1) is outputted by the SEM image detection processing. The detected image data is inputted to the image distribution control unit and passes through the image buffer counter. Next, the image distribution control unit adds distribution control data to the image data and inputs the image data to the memory bus arbitration circuit, to execute memory writing processing. Here, the memory bus arbitration circuit has a bus speed which is twice the image data input speed, to execute arbitration processing at the double speed. Network sequence control is initiated by the distribution timing control circuit, and a read request is issued to the memory bus arbitration circuit. The memory bus arbitration circuit executes the arbitration processing at the double speed of the transmission speed of the distribution network, to read desired image data. The image data thus read is sequentially distributed by the network interface circuit via the distribution network to the respective processor elements. This processing is consecutively executed in association with movement of a camera 702 to scan the dies (1) and (2).

Here, the periods of distribution latency time 715 to 718 from the initiation of the network sequence control circuit to the distribution to the respective processor elements are almost equal to each other. This will be described by referring to FIG. 1.

First, in the present embodiment, the data bus route is separately arranged for the buffer processing 34, 70, and 71 and the distribution processing 74, 73, and 61, to thereby implement a bus configuration including the memory bus arbitration circuit 40. Also, there is disposed the direct memory access circuit 38 which analyzes a communication packet to directly access a physical memory address. As a result, the CPU and the OS are not required for the access from buffer memory control and the distribution processing to the main memory 41; hence, independent control is possible, to thereby solve the contention.

Next, to suppress the variation in the distribution processing latency due to the contention between the distribution control and the buffering processing, the distribution timing control 35 is carried out using the distribution control table 33 and the InfiniBand® network communication processing is configured by the sequence control circuit 36. The distribution control table 33 includes the transmission data size, the distribution destination processor number, and the like; and at data input, by adding these parameters to the data in advance, the load on the distribution processing is mitigated.

Further, there is disposed the network communication sequence control circuit 36 to cooperate with the distribution timing control circuit 35 which monitors the quantity of data to activate the distribution processing at a fixed interval of time. This results in that the network control is performed without using the CPU and the OS and the period of distribution control time for the InfiniBand® network is predictable and the processing suspension does not occur during the processing by interruption or the like; hence, the periods of distribution latency time 715 to 718 are almost equal to each other, to thereby suppress the variation in the distribution latency due to the interruption.

As above, according to the existing method, the variation takes place in the distribution latency; in contrast thereto, according to the present patent, the variation in the distribution latency is constant and it is possible to implement parallel processing apparatus having a sufficient real-time property.

In the present invention, a bus scheduling mechanism is configured by combining the distribution timing control circuit 35 which uses the values of the image buffer counter 32 and the distribution control table 33 with the network sequence control circuit 36 which is activated by the distribution timing control circuit 35 shown in FIG. 1; it is hence possible to make the distribution latency constant, and it is possible to implement parallel processing apparatus having a sufficient real-time property. Also, the network interface circuit is controlled by hardware, without using the CPU and the OS; hence, the shorter latency is realized and the period of time required to complete the data processing is reduced, and it is possible in the semiconductor inspection to achieve high throughput. Further, the distribution control is implementable without using the CPU and the OS and the distribution control unit can be downsized to be incorporable in the apparatus. Additionally, due to the improvement of the real-time property, the buffer memory size is reduced in the parallel control unit, which makes it possible to downsize the apparatus and to lower the cost. As above, by using the general parallel processing device with a higher real-time property in a semiconductor visual inspecting apparatus, it is possible to provide a high-throughput semiconductor visual inspecting apparatus at low cost.

### Embodiment 2

Description will now be given of a second embodiment of the semiconductor inspecting apparatus according to the present invention.

It is possible to make the distribution latency constant by configuring semiconductor inspecting apparatus including a bus scheduling mechanism for an operation, that is, in a situation in which the distribution timing control circuit 35 determines the distribution start according to a condition of the image buffer counter 32 and the distribution control table 33, and the network sequence control circuit 36 makes the network interface circuit 37 operate and the distribution control is in process; the network sequence control circuit 36 keeps a request from the distribution timing control circuit 35 in a buffer and starts new distribution control after the distribution control by the network interface circuit 37 is finished.

### Embodiment 3

Description will now be given of a third embodiment of the semiconductor inspecting apparatus according to the present invention.

A semiconductor inspecting apparatus is configured by arranging a bus scheduling mechanism to perform control in which by disposing a timer in the network sequence control circuit 36, the distribution control is activated at a fixed interval of time by use of the network interface circuit 37. The mechanism waits for a distribution activation signal 77 from the distribution timing control circuit 35 at a fixed interval of time according to the timer; when a distribution activation indication is present, the distribution control is carried out by use of the network interface circuit 37, which makes it possible to make the distribution latency constant.

Further, the semiconductor inspecting apparatus according to the present invention may also be configured, unlike in the case of the existing InfiniBand® network shown in FIG. 7, without using the CPU, the OS, the driver software, the buffer processing software, and the distribution processing software. In this case, without using the CPU and the OS, the network interface circuit is controlled by hardware; hence, the shorter latency is realized and the period of time required to complete the data processing is reduced; and there are implemented effect to achieve high throughput in the semiconductor inspection and effect to downsize the distribution control unit, to thereby make the distribution control unit incorporable in the apparatus.

In addition, the configuration may also include an InfiniBand® network implemented by combining the network sequence control circuit and the network interface circuit. In this situation, there can be obtained effect that a general parallel processing device including the InfiniBand® network may be adopted as the image processing device.

Also, there may be employed a configuration in which not the InfiniBand® network, but a general network protocol requiring protocol processing based on a combination of the network sequence control circuit and the network interface circuit is utilized. In this situation, the general parallel processing device including the general network protocol may be adopted as the image processing device.

Further, there may be employed a configuration in which not the InfiniBand® network, but an Ethernet (registered trademark) based on a combination of the network sequence control circuit and the network interface circuit is used. In this situation, a general parallel processing device including the Ethernet protocol may be adopted as the image processing device.

Also, there may be employed a configuration in which by using the InfiniBand® network, the data bus route is constructed to be separately arranged for the buffer processing 34, 70, and 71 and the distribution processing 74, 73, and 61 such that the CPU and the OS are not required for the main memory access from buffer memory control and the distribution processing, to thereby implement independent control. In this situation, it is possible to solve the contention regarding the buffering of data in the main memory and the distribution control and to solve the contention taking place due to the data transmission schedule (timing) control.

In addition, there may be employed a configuration in which as for the port to which the successive image data is inputted, an image is inputted directly to the distribution control unit 60 without using the network interface circuit. In this situation, it is possible to reduce the cost of the apparatus and to achieve the shorter latency since the network interface is not used.

### REFERENCE SIGNS LIST

1 Inspection chamber, 2 Condenser lens, 3 Electron beam drawing electrode, 4 Electron gun, 5 Electron beam, 6 Blanking deflector, 7 Iris, 8 Scanning deflector, 9 Reflector, 10 Secondary electron detector, 11 Secondary electrons, 12 ExB deflector, 13 Objective lens, 15 Sample stage, 16 Target objective substrate, 17 X stage, 18 Y stage, 19 Reverse bias power source, 20 Preamplifier, 21 AD converter, 22 Preamplifier driving power source, 23 AD converter driving power source, 24 high-voltage power source, 25 Deflection control unit, 26 Objective lens control unit, 28 Stage drive control unit, 30 Buffer memory, 32 Image division control unit, 33 Distribution table, 39 Overall control unit (control unit), 42 Route switch, 48, 49, 50, 51, 900 Processor element, 53 Monitor, 55 Secondary electron detecting unit, 62 SEM visual inspecting apparatus, 63 Image processing unit, 306, 307, 308, 309, 310 Processor element, 800 Transfer destination processor element ID, 801 Division number on wafer, 802 Image coordinates on wafer, 803 Transfer image size, 804 Wafer image data, 901 Input and output controller, 902 Image memory, 903 Processor device, 904 Processor element ID

1. A semiconductor inspecting apparatus, comprising
an inspecting unit which images a surface of a target inspection object;
a detecting unit which detects reflection light from the surface of the target inspection object imaged by the inspecting unit; and
a processing unit which processes an image based on the reflection light from the surface of the target inspection object detected by the detecting unit and inspects the surface of the target inspection object, wherein
the processing unit comprises an image distribution control unit which distributes the image and an image processing unit which processes the image distributed by image distribution control unit and
the image distribution control unit comprises an image buffer counter which counts an input image quantity of the image, a distribution control table which stores therein information regarding the image, and a distribution timing control circuit which determines distribution start timing of the image based on the input image quantity counted by the image buffer counter and the information regarding the image from the distribution control table.

2. The semiconductor inspecting apparatus according to claim 1, further wherein the image distribution control unit comprises a network sequence control circuit which issues an indication to execute distribution processing of the image to the image processing unit based on an indication of the distribution start timing from the distribution timing control circuit and a network interface circuit which distributes the data to the image processing unit based on the indication regarding the distribution processing of the image from the network sequence control circuit.

3. The semiconductor inspecting apparatus according to claim 1, wherein in a situation in which the network sequence control circuit receives the indication of the distribution start timing from the distribution timing control circuit, if the network interface circuit is conducting distribution control of an image, the network sequence control circuit keeps the distribution start timing from the distribution timing control circuit in a buffer and transmits the indication of the distribution start timing to the network interface circuit after the distribution control of the image is finished in the network interface circuit.

4. The semiconductor inspecting apparatus according to claim 1, wherein the network sequence control circuit comprises a timer and transmits the indication of the distribution start timing from the distribution timing control circuit to the network interface circuit at a predetermined interval of time by use of the timer.

5. The semiconductor inspecting apparatus according to claim 2, wherein in the distribution timing control circuit, when a counter value from the image buffer counter is equal to a coordinate position of the distribution control table from the distribution control table, the distribution start timing to activate the network sequence control circuit is indicated.

6. The semiconductor inspecting apparatus according to claim 2, wherein the image based on the reflection light detected by the detecting unit is transmitted from the detecting unit directly to the image distribution control unit, not using the network interface circuit.

7. The semiconductor inspecting apparatus according to claim 1, wherein the image processing unit processes the image transmitted from the image distribution control unit by a plurality of parallel processors.

8. The semiconductor inspecting apparatus according to claim 7, wherein the image divided by the image distribution control unit is transmitted by changing a route thereof to either one of the plurality of parallel processors.
